(19) United States
(12) Patent Application Publication
(10) Pub. No.: US 2026/0219754 A1
(43) Pub. Date: Jul. 30, 2026

(54) SYSTEM AND METHOD FOR CLOSED LID INTERFACE FOR A LAPTOP TYPE INFORMATION HANDLING SYSTEM

(71) Applicant: Dell Products LP, Round Rock, TX (US)

(72) Inventors: Rachid M. Alameh, Crystal Lake, IL (US); Daniel L. Hamlin, Round Rock, TX (US)

(73) Assignee: Dell Products LP, Round Rock, TX (US)

(21) Appl. No.: 19/038,542

(22) Filed: Jan. 27, 2025

(51) Int. Cl. G06F 3/044; G06F 1/16

(52) U.S. Cl. CPC G06F 3/044; G06F 1/1616

(57) ABSTRACT

An information handling system with a closed lid interface system comprising a hardware processor and a memory with a display device lid chassis having a closed lid interface system with a sensor structure comprising a plurality of actuation sensors disposed under an interface panel in an outer surface of the display device lid chassis to detect a sensor actuation from the interface panel when a lid sensor detects a closed lid orientation of the information handling system. The sensor structure is operatively coupled to a hardware microcontroller driver disposed under the outer surface of the display device lid chassis to receive the sensor actuation from at least one of the plurality of actuation sensors for use by a closed lid interface control module to translate the sensor actuation into a quick access input command for the information handling system executing in the closed lid orientation.

### FIELD OF THE DISCLOSURE

The present disclosure generally relates to a sensor system and executing computer-readable program code instructions for interacting with a laptop type information handling system. The present disclosure more specifically relates systems and methods for an interface on an outer shell of a display chassis lid for controlling a laptop type information handling system with a closed lid.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of software applications that may still execute, for example on a laptop type information handling system, when a display chassis lid is closed.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system with a display device lid chassis and a sensors for a closed lid interface system executing machine readable code instructions for a closed lid interface control module according to an embodiment of the present disclosure;

FIG. 2A is a perspective view graphic diagram illustrating a laptop type information handling system and a first sensor system for a closed lid interface system according to an embodiment of the present disclosure;

FIG. 2B is a front view graphic diagram illustrating a laptop type information handling system with a closed lid and a first sensor system that is a capacitive sensor system for a closed lid interface system according to an embodiment of the present disclosure;

FIG. 3A is a top view graphic diagram illustrating a laptop type information handling system and magnified inset of a second set of sensors that is a capacitive sensor system for a closed lid interface system according to another embodiment of the present disclosure;

FIG. 3B is a side view graphic diagram illustrating a laptop type information handling system display chassis lid and a second set of sensors that is a capacitive sensor system for a closed lid interface system according to another embodiment of the present disclosure;

FIG. 4A is a side view graphic diagram illustrating a laptop type information handling system display chassis lid and a third set of sensors that is a piezo sensor system for a closed lid interface system according to yet another embodiment of the present disclosure;

FIG. 4B is a side view graphic diagram illustrating a laptop type information handling system chassis lid and a third set of sensors that is a piezo sensor system for a closed lid interface system according to yet another embodiment of the present disclosure;

FIG. 5A is a side view graphic diagram illustrating a laptop type information handling system display chassis lid and magnified inset of a fourth set of sensors that is a strain gauge sensor system for a closed lid interface system according to yet another embodiment of the present disclosure;

FIG. 5B is a side view graphic diagram illustrating a laptop type information handling system chassis lid and a third set of sensors that is a strain gauge sensor system for a closed lid interface system according to another embodiment of the present disclosure; and

FIG. 6 is a flow diagram showing a method of operating a closed lid interface system with sets of sensors while executing machine-readable program code instructions for a closed lid interface control module for control of a laptop type information handling system in a closed lid orientation according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Information handling systems may include any number of a plurality of input and output devices that allow a user to interact with the information handling system. In a laptop type information handling system, interaction with those input and output devices occurs when a laptop display chassis lid is open to access a video display device, keyboard, touchpad, and other interface input output devices. However, the information handling system may continue to operate when the laptop type information handling system is in a closed lid orientation and a user may interface with speakers, microphones, or wirelessly coupled or wire-coupled remote peripheral input/output (IO) devices. However, often interaction may still require a user to access the onboard input/output devices, such as control keys, keyboard, or touchpad, on the laptop type information handling system to conduct quick access controls over executing software applications, such as communication, voice dictation, alert control, audio control applications or other applications. Requiring access to onboard I/O devices within the closed lid orientation may be inconvenient or a nuisance for the user when only quick access controls are needed to control executing software or firmware on the information handling system. Often these quick access controls are located at or above a keyboard on a base chassis of the laptop information handling system and are not accessible without opening the display device lid chassis of the laptop type information handling system. Quick access controls placed on the outside display device lid chassis of a laptop information handling system such as buttons, dials, a touchpad or the like for control of a lid closed information handling system are aesthetically compromised, may be costly for manufacture, and may be subject to breakage.

Embodiments of the present disclosure include use of one or more sensors already on the laptop type information handling system or concealed within, around, or as part of the outer surface of the display device lid chassis or a logo on the display device lid chassis of the closed lid information handling system. As a result, the closed lid interface system is used for quick access control of a closed lid information handling system but does not negatively affect the aesthetic look of the display device lid chassis outer surface. The closed lid interface system of embodiments herein may utilize existing sensors on the base chassis of the information handling system or uses sensors integrated into or around a logo or under the display device lid chassis outer surface cover itself.

In one embodiment, a first sensor system that is a capacitive sensor system for a closed lid interface system may utilize capacitive sensors of a touchpad on a base chassis repurposed when disabled with a closed lid or an installed strip capacitive sensor on an edge of the base chassis or the display chassis to detect a movement of the top or front edge of the display chassis lid with respect to the front edge of the base chassis when squeezed or pressed to actuate like a button. Such an actuation by a squeeze or press of the top or front edge of the display chassis lid with respect to the front edge of the base chassis causes a compression movement that is detected by the strip capacitive sensor or the repurposed capacitive touchpad in embodiments herein. This detected squeeze with the strip capacitive sensor or repurposed capacitive touchpad may then be submitted to a closed lid interface control module executing on a hardware processing resource such as a hardware processor or embedded controller as a button actuation type input or plural button actuation inputs and translated into one or more IO commands for quick access controls. These squeeze actuation detected by the strip capacitive sensor or the repurposed capacitive touchpad may be used based on a number of squeezes, squeeze pattern, or duration of a squeeze detected for quick access controls of a closed lid interface system for the software applications executing the closed lid information handling system in a first embodiment.

In an embodiment, a second sensor system that is a second capacitive sensor system for a closed lid interface system may utilize an array or geometrically placed arrangement of the capacitive sensors made of a capacitive sensor material may be disposed on or just under the surface of the display chassis lid cover. A logo structure or an interface panel surface structure on the display chassis lid cover may be repurposed, used to detect touch by a user on the logo or interface panel surface structure formed on the display chassis lid cover to actuate quick access controls. The array or geometrically placed capacitive sensors is made formed around a perimeter of a geometric shape hidden as part of a logo and may actuate like a button or plural buttons or operate relative to one another via relational touch sensing among the array or geometrically placed arrangement of the capacitive sensors. Such an actuation by touch or sweep across the array or geometrically placed arrangement capacitive sensors in embodiments herein may provide for button like actuation, directional x-y actuation, rotation wheel type scrolling, or sweep/scroll type actuation for quick access controls in embodiments herein. Various actuations with the array or geometrically placed arrangement capacitive sensors provide for plural quick access controls of a closed lid interface system for the software applications executing the closed lid information handling system in an embodiment.

In another embodiment, a third sensor system that is a piezo sensor system for a closed lid interface system may utilize a plurality of piezo sensors disposed under a floating logo on the display chassis lid cover. The floating logo or an interface panel surface structure is disposed atop a pedestal of and having logo pins extending through the digital display top cover to the deflectable piezo sensors below. The piezo sensors may respond to a slight deflection of the logo structure or the or an interface panel surface structure on the pedestal and may be directionally arranged under the pedestal logo or be center actuated to detect slight deflection of the logo structure or the interface panel surface structure in embodiments herein. The directionally arranged piezo sensors may be actuated like a button for center deflection or as four way or more x-y directional actuation among the directionally placed arrangement of the piezo sensors. Such an actuation by center actuation or directional x-y actuation may be used for quick access controls in embodiments herein. Various actuations with the logo structure or the interface panel surface structure and directionally arranged piezo sensors provide for plural quick access controls of a closed lid interface system for the software applications executing the closed lid information handling system in another embodiment.

In yet another embodiment, a fourth sensor system that is a strain gauge sensor system for a closed lid interface system may utilize a plurality of strain gauge sensors disposed under any location of the display chassis lid cover. Slight deflection of the metal or other material of the digital display top cover is detected by the deflectable strain gauge sensors embedded within or below the top surface of the digital display top cover. Thus, slight deflection of the top surface of the digital display top cover may deflect one or more of a plurality of disposed strain gauges for a button type actuation or for four way or more x-y directional actuation. Since the strain gauge sensors may respond to a slight deflection of the metal or other surface of the display chassis lid cover, a centrally located strain gauge or one disposed under a logo be center-actuated to detect slight deflection of the outer surface of the display chassis lid cover as a button type actuation in some embodiments herein. In other embodiments, the directionally arranged strain gauge sensor locations may be actuated at different directional locations of the outer surface of the display chassis lid cover as four way or more x-y directional actuation among the directionally placed arrangement of the strain gauge sensors. Such an actuation by center actuation or directional x-y actuation may be used for quick access controls in embodiments herein. Various actuations with the centrally located or directionally arranged strain gauge sensors provide for quick access controls of a closed lid interface system for the software applications executing the closed lid information handling system in yet another embodiment.

Each of the closed lid interface systems with any of the plural sensor systems of embodiments herein may be accompanied by integrated lighting in some embodiments for actuation indicators, feedback from actuation, or for designation of the closed lid interface system located on the outer surface of the display chassis lid cover or a logo or an interface panel surface structure therein or thereon. In further embodiments, actuation of the closed lid interface systems for quick access controls input may be operatively coupled to a printed circuit board under the surface of the display chassis lid cover that includes a hardware microcontroller driver and low power source. The hardware microcontroller driver receives actuation inputs from any of the sensor types and forwards those to the information handling system. In an embodiment, execution of code instructions of a closed lid interface control module at the information handling systems receives these sensor actuation inputs and translates corresponding input/output (IO) commands to the information handling system for quick access controls of software, firmware, or hardware executing thereon. Further, the closed lid interface control module may provide responsive feedback to a sensor actuation input to indicate to a user that the sensor actuation has been received. Such responsive feedback may be a haptic feedback, a tone played at a speaker or a light indicator at one or more lights on the information handling system, such as the integrated lighting with the closed lid interface system.

The present systems and methods allow for closed lid control of a laptop type information handling system based on already-present or on below-surface sensor systems under a display chassis lid logo thereon to maintain aesthetics of the display chassis lid by a user of the closed lid information handling system. This closed-lid interface system provides for the quick access controls of executing software or firmware on the laptop information handling system in a closed lid orientation with minimal effort for engagement for actuation and without the user having to open the lid and in embodiments herein.

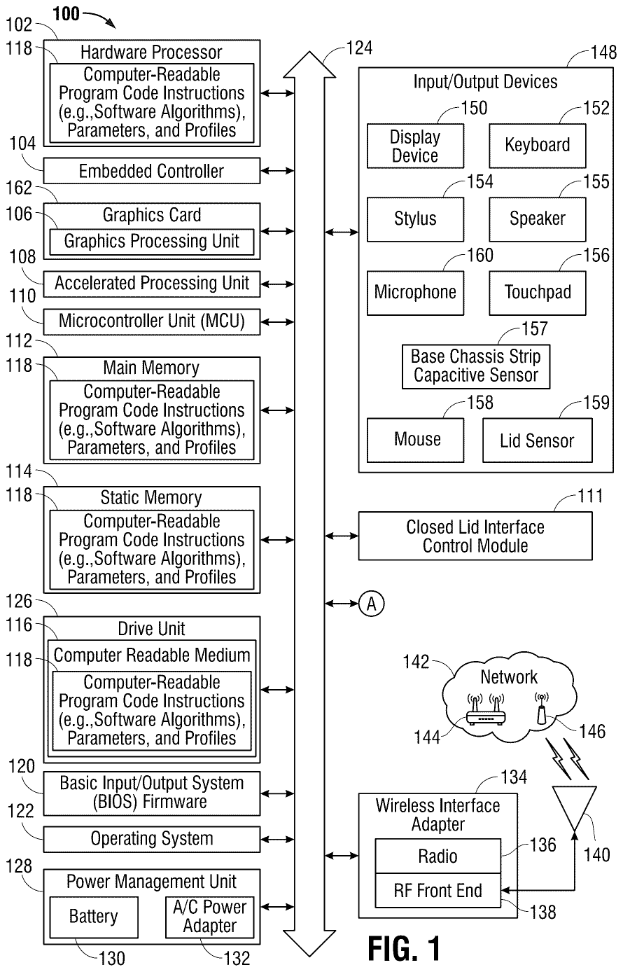

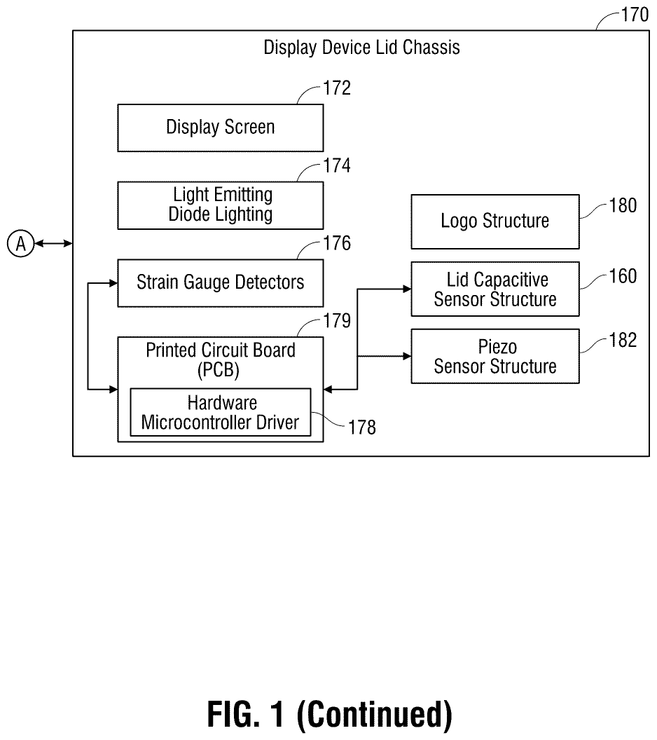

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality. In one particular embodiment of the present disclosure, the information handling system 100 is a laptop type information handling system with a display device lid chassis 170 and a base chassis or keyboard chassis.

In a networked deployment, the information handling system 100 may operate in the capacity of a client computer in a server-client network environment, or as a peer computer system within a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be accessible by hardware processing resources using that main memory 112. Computer-readable program code instructions stored in static memory 114, main memory 112, or drive unit 126 may be involved in invoking such computer-readable program code instructions to main memory 112 according to embodiments herein. Additional components of the information handling system 100 may include one or more storage devices such as static memory 114 or drive unit 126. The information handling system 100 may include or interface with one or more communications ports for communicating with external devices a mouse 158, a stylus 154, or external display device 150 via various wired or wireless connections. Further, the information handling system 100 may include various input and output (I/O) devices 148, such as a touchpad 156, a keyboard 152, a digital display device 150, speaker 155, a microphone 160, a lid sensor 159 or any combination thereof. Portions of an information handling system 100 may themselves be considered information handling systems 100.

Information handling system 100 may include devices or modules that embody one or more of the devices or execute instructions for one or more systems and modules. The information handling system 100 may execute computer-readable program code instructions (e.g., software algorithms) parameters, and profiles 118 that may operate on servers or systems, remote data centers, or on-box in individual client information handling systems according to various embodiments herein. In some embodiments, it is understood any or all portions of computer-readable program code instructions (e.g., software algorithms) parameters, and profiles 118 may operate on a plurality of information handling systems 100.

The information handling system 100 may include the hardware processor 102 such as a central processing unit (CPU) or other hardware processing resource (e.g., 104, 106, 108, 110). Any of the hardware processing resources may operate to execute computer readable code instructions that are either firmware or software code, such as those software systems and modules described herein. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 storing computer-readable program code instructions (e.g., software algorithms) parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various wired or wireless I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 110, APU 108, and/or others may execute one or more bus drivers in order to transmit this data between the information handling system 100 and the wired or wireless input/output devices 148 described herein. In an embodiment, the information handling system 100 may be in wired or wireless communication with the wired or wireless I/O devices 148 such as a keyboard 152, a mouse 158, standalone digital display device 150, stylus 154, trackpad 156, microphone 160, among other peripheral devices. In an embodiment, for example, information handling system 100 may execute machine readable code instructions of software applications or firmware to generate video data, such as via a GPU, for images to be presented on the digital display device 150. The video data may be transmitted to a standalone digital display device 150 via wired or wireless communication according to embodiments herein. The digital display device 150 in an embodiment may function as a liquid crystal display (LCD), an organic light emitting diode (OLED), a flat panel display, or a solid-state display and be a display screen 172 integrated within a display device lid chassis 170 of the information handling system 100.

Additionally, as described herein, the information handling system 100 may include or be operatively coupled to a cursor control device (e.g., a trackpad 156, or gesture or touch screen input), a stylus 154, and/or a keyboard 152, among others that allows the user to interface with the information handling system 100 via the digital display device 150. In embodiments of the present disclosure, the information handling system 100 may include a closed lid interface system from various sensors 160, 176 and 182 disposed in or under the outer cover of the display device lid chassis 170 or a logo thereon of the information handling system 100. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the wired or wireless I/O devices 148 according to the embodiments described herein. The present specification contemplates that the wired or wireless I/O devices 148 may be wired or wireless.

A network interface device of the information handling system 100 may be wired or wireless such as shown with wireless interface adapter 134 that can provide wireless connectivity among devices such as with Bluetooth® or to a network 142, e.g., a wide area network (WAN), a local area network (LAN), wireless local area network (WLAN), a wireless personal area network (WPAN), a wireless wide area network (WWAN), or other network. In embodiments described herein, the wireless interface device 134 with its radio 136, RF front end 138 and antenna 140 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth®, BLE, proprietary RF protocol, or other WPAN or WLAN protocols and plural such protocols may be used for communication with and among any wireless peripheral device to be paired or paired with the information handling system 100 or other information handling systems.

In other embodiments, a WAN, WWAN, LAN, and WLAN may each include an AP 144 or base station 146 used to operatively couple the information handling system 100 to a network 142 via a wireless interface adapter 134. In a specific embodiment, the network 142 may include macro-cellular connections via one or more base stations 146 or a wireless AP 144 (e.g., Wi-Fi), or such as through licensed or unlicensed WWAN small cell base stations 146. Connectivity may be via wired or wireless connection. For example, wireless network wireless APs 144 or base stations 146 may be operatively connected to the information handling system 100. Wireless interface adapter 134 may include one or more RF (RF) subsystems (e.g., radio 136) with transmitter/receiver circuitry, modem circuitry, one or more antenna RF (RF) front end 138 circuits, one or more wireless controller circuits, amplifiers, antennas 140 and other circuitry of the radio 136 such as one or more antenna ports used for wireless communications via multiple radio access technologies (RATs). The radio 136 may communicate with one or more wireless technology protocols.

In an embodiment, the wireless interface adapter 134 may operate in accordance with any wireless data communication standards. To communicate with a wireless local area network, standards including IEEE 802.11 WLAN standards (e.g., IEEE 802.11ax-2021 (Wi-Fi 6E, 6 GHZ)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes computer-readable program code instructions of software or firmware the information handling system 100, such as via a hardware processor 102, embedded controller 104, a graphics processing unit (GPU) 106, an accelerated processing unit APU) 109, a microcontroller unit (MCU) 110 or a hardware microcontroller driver 178 to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit (ASIC). Accordingly, the present system encompasses a hardware processing resource executing computer-readable program code instructions of software or firmware as well as hardware implementations or any combination.

In accordance with various embodiments of the present disclosure, the methods described herein may be implemented by firmware or software programs executable by a hardware processor 102, embedded controller 104 or a hardware microcontroller driver unit 178 at the device lid chassis 170. Further, in an exemplary, non-limited embodiment, the information handling system may execute software or firmware via hardware processing resources 102, 104, 106, 108, or 110 to receive sensor input, interpret and transmit input/output (IO) commands from that sensor input, execute the IO commands at the information handling system, and generate responsive feedback to actuation of the closed lid interface system actuation of the sensors 156, 160, 176, or 180 in embodiments herein. Processing resources may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable program code instructions, parameters, and profiles 118 or receives and executes computer-readable program code instructions, parameters, and profiles 118 responsive to a propagated signal, so that a hardware device connected to a network 142 may communicate voice, video, or data over the network 142. Further, the computer-readable program code instructions, parameters, and profiles 118 may be transmitted or received over the network 142 via the network interface device or wireless interface adapter 134.

The information handling system 100 may include a set of computer-readable program code instructions, parameters, and profiles 118 that may be executed to cause the computer system to perform any one or more of the methods or computer-based functions disclosed herein. For example, computer-readable program code instructions, parameters, and profiles 118 may be executed by a hardware processor 102, GPU 106, EC 104, APU 108, NPU 110, or any other hardware processing resource and may include software agents, or other aspects or components used to generate video data for presentation of images at the standalone digital display device 150 during execution of the methods and systems described herein.

Various software modules comprising application computer-readable program code instructions, parameters, and profiles 118 may be coordinated by an operating system (OS) 122, and/or via an application programming interface (API) include a unified device API described herein. An example OS 122 may include Windows®, Android®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a computer-readable medium for storage of one or more sets of machine-readable program code instructions, parameters, or profiles 118 described herein. The disk drive unit 126 or static memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the static memory 114, and/or within the disk drive 126 during execution by the hardware processor 102, EC 104, APU 108, NPU 100, or GPU 106 of information handling system 100.

Main memory 112 or other memory of the embodiments described herein may contain computer-readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain computer-readable medium (not shown), such as NOR or NAND flash memory in some example embodiments. The applications and associated APIs, for example, may be stored in static memory 114 or on the disk drive unit 126 that may include access to a machine-readable code instructions, parameters, and profiles 118 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, the APU 108, the NPU 110, the video/graphic display device 150, or other wired or wireless I/O devices 148 such as the mouse 158, the stylus 154, the keyboard 152, and the trackpad 156 and other components that may require power when a power button has been actuated by a user. In an embodiment, the PMU 128 may monitor power levels and be electrically coupled to the information handling system 100 in embodiments herein to provide this power. The PMU 128 may be coupled to the bus 124 to provide or receive data or machine-readable code instructions. The PMU 128 may regulate power from a power source such as the battery 130, or AC power adapter 132. In an embodiment, the battery 130 may be charged via the AC power adapter 132 and provide power to the components of the information handling system 100, via wired connections, or when AC power from the AC power adapter 132 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 116 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described, the information handling system 100 includes a closed lid interface system according to one or more embodiments herein. In embodiments, the information handling system 100 is a laptop type information handling system. The closed lid interface system utilizes existing capacitive sensors or sensors on or under an outer surface of a display device lid chassis, such as 160, 174, and 182 in various embodiments, for closed lid control of a laptop type information handling system 100 via tactile interface with the display device lid chassis. The sensors used for the closed lid interface system may be already-present sensors, such as capacitive sensor array of the touchpad 158 or another base chassis strip capacitive sensor 157 on a base chassis or a facing surface of the display device lid chassis 170 in an embodiment. In other embodiments, the closed lid interface system may be comprised of lid capacitive sensor structure 160, strain gauge detectors 176, or piezo sensor structure 182 disposed on or below an outer surface of the display device lid chassis 170 or around or under a display chassis lid structure 180 thereon to maintain aesthetics of the display chassis lid 170 of the closed lid information handling system. This closed lid interface system provides for the quick access controls of computer-readable program code software or firmware 118 executing on the laptop information handling system when in a closed lid orientation with minimal effort and without the user having to open the lid in embodiments herein.

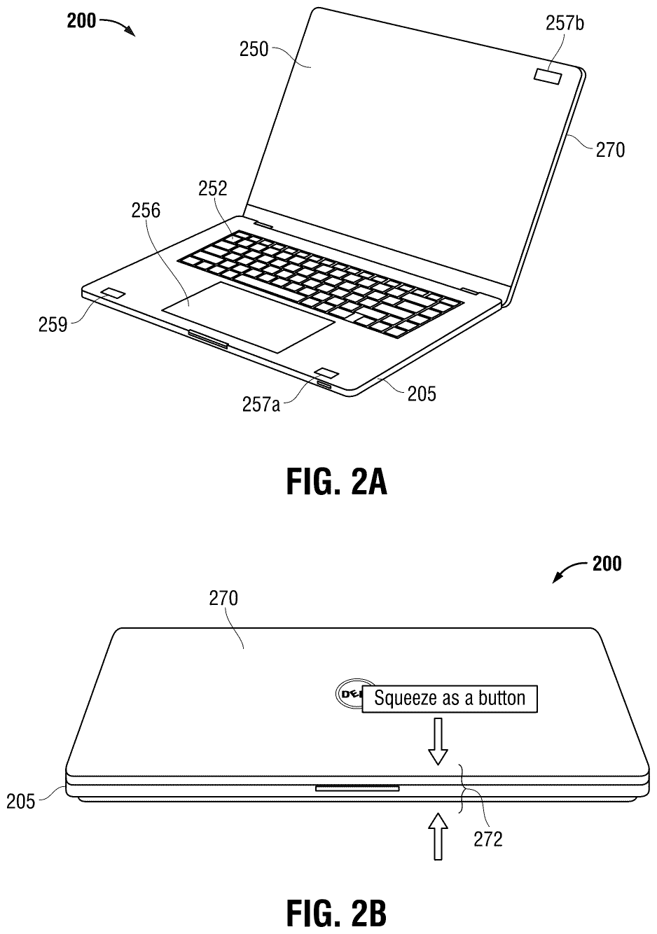

The closed lid interface system in embodiments herein includes a printed circuit board (PCB) 179 which may include a hardware microcontroller driver 178, power source, switch circuitry, light emitting diode lighting source 174, or other supporting circuitry of the closed lid interface system. The PCB 179 is disposed within or at the display device lid chassis 170 in some embodiments, but may be located elsewhere in the information handling system 100 in other embodiments. PCB 179 is operatively coupled between the sensors 160, 174, and 182 on display device lid chassis 170 and a data bus 124 of the laptop type information handling system 100 in embodiments herein. PCB 179 or a hardware microcontroller driver 178 may be operatively coupled to touchpad 158 upon being disabled when the display device lid chassis 170 is closed in other embodiments. In yet other embodiments, PCB 179 or a hardware microcontroller driver 178 may be operatively coupled to a base chassis strip capacitive sensor 157, such as a carbon strip capacitive sensor or other capacitive sensor, in a base chassis or display device lid chassis 170 of the information handling system. The base chassis strip capacitive sensor 157, as shown further in FIGS. 2A and 2B, may detect the base chassis of information handling system 100 being compressed with actuation of the display device lid chassis 170 and is referred to herein as a base chassis strip capacitive sensor 157 although it may be located on either internal face of the base chassis or the display device lid chassis 170 in a closed lid orientation.

Hardware microcontroller driver 178 is operatively coupled to receive actuation sensor inputs from the lid capacitive sensor structure 160, strain gauge detectors 176, or piezo sensor structure 182 during operation of the closed lid interface system in embodiments herein. In other embodiments, hardware microcontroller driver 178 may receive actuation sensor inputs from a base chassis strip capacitive sensor or a touchpad 156 of capacitive sensors when disabled by detection of a closed lid orientation via lid sensor 159. In embodiments, lid sensor 159 may be hall sensors, microphones 160, light sensor, hinge sensor, gyro inertial motion unit sensors, or others to detect the orientation of the display device lid chassis 170 relative to a base chassis of the information handling system 100 that is used to determine any orientation modes, for example, laptop open orientation, closed lid orientation, tablet orientation, easel orientation, tent orientation or other orientations.

As described, embodiments of the present disclosure include use of one or more sensors already on the laptop type information handling system or concealed on, within, around the display device lid chassis outer surface 170, or as part of a logo structure 180 on the display device lid chassis outer surface 170 of the closed lid information handling system 100 for a closed lid interface system of embodiments herein. The resulting closed lid interface system for quick access control of a closed lid information handling system 100 uses sensors 160, 174, and 182 so disposed in the digital display device lid chassis 170 or existing sensors, such as touchpad 156 when disabled for touch activity, such that the closed lid interface system minimizes its effect on the aesthetic look of the display chassis lid outer surface. The closed lid interface system of embodiments herein may utilize sensors 156, 157 on the base chassis of the information handling system as an actuation sensor structure of the closed lid interface system in one embodiment. The closed lid interface system of embodiments herein may utilize sensors 160, 174, and 182 integrated on, into, or around the display device lid chassis 170 or under a logo structure 180 the interface panel surface structure thereon, such as sensors as an integral part of the logo structure 180 or the interface panel surface structure. These configurations of sensors may operate as an actuation sensor structure with a hardware microcontroller driver 178 to receive actuation sensor inputs from them in other embodiments of the present disclosure.

The, logo structure 180 or an interface panel surface structure is made from conductive material and acts as a sensor in some embodiments herein. The closed lid interface system may be a low power system that may limit impact on operation of the hardware processor 102 or power of the closed lid information handling system 100, but may still provide quick access control IO commands via execution of computer readable program code of closed lid interface control module 111 pursuant to sensor actuation data received from the hardware microcontroller driver 178 in embodiments herein. In various capacitive embodiments herein, where under or as an integral part of the logo structure 180 or an interface panel surface structure acts as a capacitive sensor structure or the repurposed touchpad 156 or the base chassis strip capacitive sensor 157, these embodiment also offers proximity detection before touch to ready the system and light up areas of interest with lighting such as light emitting diode (LED) lighting 174.

In one embodiment, a closed lid interface system uses a capacitive sensor system with capacitive sensors of a touchpad 156 on a base chassis repurposed when disabled with a closed lid as detected by a lid sensor 159. In another embodiment, the closed lid interface system uses a capacitive sensor system with an installed base chassis strip capacitive sensor 157 disposed towards an outer or front edge in the base chassis or towards the outer or top edge of an inner face of the display device lid chassis 170. The touchpad 156 or the base chassis strip capacitive sensor 157 detects a change in detected capacitance during a compression movement of the top or front edge of the display device lid chassis 170 with respect to the front edge of the base chassis when the display device lid chassis 170 that is actuated by a squeeze or a press.

Such an actuation by a squeeze or press of the top or front edge of the display device lid chassis 170 with respect to the front edge of the base chassis causes a compression movement that is detected by the base chassis strip capacitive sensor 157 on either base or display chassis or by the repurposed capacitive touchpad 156 in embodiments herein. This detected squeeze or press actuation with the base chassis strip capacitive sensor 157 or repurposed capacitive touchpad 156 is detected by the hardware microcontroller driver 178 in embodiments herein. The detected squeeze or press actuation input may then be submitted by the hardware microcontroller driver 178 to a closed lid interface control module 111 executing on a hardware processing resource such as a hardware processor 102, embedded controller 104, or a designated microcontroller unit (MCU) 110. The computer readable program code of the closed lid interface control module 111 may receive the detected squeeze or press actuation input and generate a button actuation type IO command, also referred to as an input command, in one embodiment. In further embodiments, the closed lid interface control module 111 may receive plural squeeze or press actuation inputs in a succession, for example two or more squeezes or presses actuated within a threshold timeframe, as a second actuation type IO command. In yet other embodiments, the closed lid interface control module 111 may receive one or more squeeze or press actuation inputs for a duration exceeding a threshold timeframe as a third actuation type IO command. These squeeze or press actuations or press patterns of the display device lid chassis detected by the base chassis strip capacitive sensor 157 or the repurposed capacitive touchpad 156 may be determined from among a plurality of quick access control IO commands based on a number of squeezes or presses or duration of a squeeze or press detected for quick access control by closed lid interface control module 111 for the software applications executing on the closed lid information handling system 100 in an embodiment herein.

In an embodiment, a closed lid interface system uses a lid capacitive sensor structure 160 utilizing an array or geometrically placed arrangement of capacitive sensors around a perimeter of a geometric shape. The geometrically placed arrangement of capacitive sensors are made of a conductive and capacitive sensor material disposed on or just under the surface of the outer cover of the display device lid chassis 170 or under a capacitive logo structure 180 or an interface panel surface inset in the display device lid chassis 170. The array or geometrically arranged capacitive sensors made of any capacitive sensor material, and may be indium tin oxide (ITO) that is disposed on a flex circuit board under a capacitive logo or a carbon deposit under the logo structure 180 or under the interface panel surface inset in the display device lid chassis 170. In an embodiment, the capacitive logo structure 180 or the interface panel surface inset in the display device lid chassis 170 may be made of metal or plastic. The array or geometrically arranged capacitive sensors detect touch by a user on the capacitive logo structure 180 or the interface panel surface inset in the display device lid chassis 170 to actuate the ITO capacitor sensors for quick access controls. The array or geometrically arranged capacitive sensors under the logo structure 180 or as integral part of the logo structure 180 body/material operates as the lid capacitive sensor structure 160 and includes one or more flex circuits or wires passing through a via in the surface of the display device lid chassis 170 to a flexible printed circuit board (PCB) 179 and hardware microcontroller driver 178 within the display device lid chassis 170 in an embodiment.

A user may wake up and light up the LED lighting 174 illumination with approaching finger over the lid capacitive sensor structure 160, actuate the lid capacitive sensor structure 160 with a center actuation of a capacitive logo structure 180 or the interface panel surface inset in the display device lid chassis 170 in an embodiment. A user may actuate the lid capacitive sensor structure 160 with a center actuation of a capacitive logo structure 180 or the interface panel surface inset in the display device lid chassis 170 for selection among plural buttons on different sides of the capacitive logo structure 180 or the interface panel surface inset in the display device lid chassis 170 by a user's finger in another embodiment. In a one embodiment, the array or geometric arrangement of capacitive sensors used with the lid capacitive sensor structure 160 may operate relative to one another via relational touch sensing among the geometrically arranged capacitive sensors for x-y directional input, scrolling, or swipe type actuation by the finger of a user. It is also contemplated that the array or geometric arrangement of capacitive sensors used with the lid capacitive sensor structure 160 may be any number or geometric arrangement under the capacitive logo structure 180 such that an actuation by touch or sweep of a finger across the capacitive logo structure 180 or the interface panel surface inset in the display device lid chassis 170 is detected by the capacitive sensors geometrically placed arranged around a perimeter of a geometric shape to provide for directional x-y actuation, swipe actuation, or scroll actuation for quick access controls in embodiments herein.

In various embodiments, a ring, rectangle, square, oval or other geometric arrangement of any number of capacitive sensors around a perimeter of a geometric shape is used with the lid capacitive sensor structure 160 to provide 4-way or multi-way directional touch input by a user touching any side or portion of the capacitive logo structure 180 depending on the number of capacitive sensor used in the geometric arrangement. In one embodiment, the conducive logo structure 180 or the interface panel surface inset in the display device lid chassis 170 may be round, but the logo structure may be of any suitable shape for the logo of the information handling system 100 or any shape the interface panel surface inset in the display device lid chassis 170 is contemplated in other embodiments. In a further embodiment, it is contemplated that the geometric arrangement of capacitive sensors of the lid capacitive sensor structure 160 are arranged on a flexible PCB under the logo structure 180 or interface panel surface structure such that the logo structure 180 or interface panel surface structure is not the sensor and it does not need to be conductive. Alternatively, the flexible PCB does not contain the capacitive sensor, and a conductive logo structure 180 or interface panel surface structure is the sensor. In a latter embodiment, the flexible PCB is used to couple the conductive logo structure as the lid capacitive sensor structure to the internal hardware microcontroller driver 178. In embodiments herein, the logo structure 180 or interface panel surface structure as a lid capacitive sensor structure 160 could be conductive or at least a partially conductive surface in the display device lid chassis 170. Such that an actuation by touch or sweep of a finger across the at least partially conductive surface is detected by the geometrically placed arrangement capacitive sensors to provide for a variety of capacitive input actuation as described in embodiments herein. As with each closed lid interface system embodiment, the lid capacitive sensor structure actuation is detected at the hardware microcontroller driver 178 and transmitted to the closed lid interface control module 111. A hardware processing resource executes computer readable program code of the closed lid interface for conversion of received sensor actuation input to a capacitive touch IO command for quick access control of the closed-lid information handling system. Various actuations with the geometrically placed arrangement of capacitive sensors provide for quick access controls of a closed lid interface system for the software applications executing the closed lid information handling system in embodiments herein.

In another embodiment, a closed lid interface system uses a piezo sensor structure 182 for a closed lid interface system that includes a plurality of piezo sensors disposed under a logo structure 180 or an interface panel surface structure on the cover surface of the display device lid chassis 170. The logo structure 180 or the interface panel surface structure is disposed atop a pedestal to raise the logo structure or interface panel surface structure above the surface of the display device lid chassis 170 to allow for flexing, and includes one or more piezo engagement pins extending through vias in the cover surface of the display device lid chassis 170 to engage the deflectable piezo sensors below. The piezo sensors may respond to a slight flexing/deflection of the logo structure 180 or the interface panel surface structure on the pedestal and may be directionally arranged such that they may be center-actuated or side actuated depending on where the logo structure or the interface panel surface structure is deflected to detect piezo actuation input from a user's press on the logo structure or the interface panel surface structure. It is contemplated in some embodiments that the interface panel surface structure is used appearing as a region flush with the outer surface of the display device lid chassis 170, may be similarly situated on a pedestal with piezo engagement pins, to detect slight deflection by a user's finger in embodiments herein. In one embodiment, a plurality of piezo sensor may be disposed below the outer surface of the display device lid chassis 170 under plural piezo engagement pins for x-y multi-directional actuation as well as center actuation for button like input by press of the logo structure 180 or the interface panel surface structure.

The piezo sensors of the piezo sensor structure 182 may be of a dive-board type structure where piezo element is fixed on one side and floating on the other, described further herein, for additional sensitivity of the actuation of from the piezo engagement pins. The piezo sensors under the outer surface of the display device lid chassis 170 are operatively coupled by wire or flexible PCB 179 to the hardware microcontroller driver 178 in embodiments herein.

Such an actuation by center actuation or directional x-y actuation may be used for quick access controls in embodiments herein. In this closed lid interface system embodiment, the piezo sensor structure 182 actuation is detected at the hardware microcontroller driver 178 and transmitted to the closed lid interface control module 111 for conversion to a piezo IO command for quick access control of the closed-lid information handling system. Various actuations by a user's finger applying force or pressing on the logo structure 180 or the interface panel surface structure is conveyed to directionally arranged piezo sensors by the piezo engagement pins of a piezo sensor structure 182 to provide for quick access controls of a closed lid interface system for the software applications executing the closed lid information handling system 100 in another embodiment.

In yet another embodiment, a closed lid interface system uses a plurality of strain gauge detectors 176 disposed under any location of the outer cover surface for the display device lid chassis 170 as an actuation sensor structure. The strain gauge detection can be in the form of flexing strain gauge detector from flexing of the surface and responds to pressure and amount of pressure where slight deflection may be interpreted differently than strong deflection. Slight deflection of the metal or other material of the outer cover surface for the display device lid chassis 170 is detected by the deflectable strain gauge detectors 176 embedded within or below the outer cover surface for the display device lid chassis 170. Strain gauge detectors 176 may be solid state strain gauge detectors 176, such as linear strain gauge detectors oriented at an angle to normal of a direction or surface flex of the embedded strain gauge. Other types of strain gauges are also contemplated. Example strain gauge detectors include semiconductor piezo resistive strain gauges, capacitive strain gauges, bonded resistance strain gauges, bonded foil strain gauges, or the like in embodiments herein. Thus, slight deflection of the outer cover surface for the display device lid chassis 170 may deflect each of a plurality of disposed strain gauges for a button type actuation or relational actuation at varying strain gauge detection levels for four way or more way x-y directional actuation by a touch of a user's finger at locations on the outer cover surface for the display device lid chassis 170 in embodiments herein.

Since the strain gauge detectors 176 may respond to a slight deflection of the metal or other surface of the display chassis lid cover, a centrally located strain gauge or one disposed under a logo structure 180 or the interface panel surface structure can be center-actuated to detect slight deflection of the outer cover surface for the display device lid chassis 170 as a button type actuation in some embodiments herein. In other embodiments, the directionally arranged strain gauge sensor locations may be actuated at different directional locations across the outer cover surface for the display device lid chassis 170. In other embodiments, the amount of force/deflection applied on the surface can be used to indicate different sensor actuation inputs of the strain gauge detectors 176. For example, a slight deflection could mean slow scroll, and a hard deflection could mean fast scroll as detected as different sensor actuation inputs from a user press. As described, each directionally arranged strain gauge detector may be oriented at an angle relative to a normal direction line from the center for improved detection of strain gauge actuations as four way or more way x-y directional actuation among the directionally placed arrangement of the strain gauge detectors 176. In some embodiments, the angle of the strain gauge detectors embedded in or under the outer cover surface for the display device lid chassis 170 may be at 30 degrees or 45 degrees from a normal linear direction emanating from the center of the outer cover surface for the display device lid chassis 170 to detect plural directional flex of a user's press on the outer cover surface for the display device lid chassis 170. The strain gauge detectors 176 are disposed on or embedded into an under side of the outer cover surface for the display device lid chassis 170 and operatively coupled to a flexible PCB 179 having a hardware microcontroller driver 178 for receiving the strain gauge actuations according to embodiments herein. Such a strain gauge actuation by center actuation or directional x-y actuation may be used for quick access controls in embodiments herein. As with each closed lid interface system embodiment, the strain gauge actuation is detected at the hardware microcontroller driver 178 and transmitted to the closed lid interface control module 111 for conversion to a strain gauge IO command for quick access control of the closed-lid information handling system. Various actuations with the centrally located or directionally arranged strain gauge detectors 176 provide for quick access controls of a closed lid interface system for the software applications executing the closed lid information handling system 100 in yet another embodiment.

Each of the closed lid interface system embodiments with any of the plural sensor systems of embodiments described herein may be accompanied by integrated lighting of a light emitting diode (LED) or other lighting 174 in some embodiments. The LED or other lighting 174 may be located on flexible PCB 179 with light guide used to direct the light to under any logo structure 180 through vias or to thinned out indicator areas formed into the outer surface of the display device lid chassis 170 or the logo structure 180 or the interface panel surface structure in various embodiments herein. The LED or other lighting 174 may be used for actuation indicators, area illumination, alert indication, feedback from actuation, or for designation of the closed lid interface system location on the outer surface of the display device lid chassis 170 or for highlighting the logo structure 180 or the interface panel surface structure thereon. In further embodiments, actuation of the closed lid interface system embodiments for quick access control input actuations may be operatively coupled to the printed circuit board 179 under the outer surface of the display device lid chassis 170 that includes the hardware microcontroller driver 178 as well as a low power source or operative coupling to the power source, such as via PMU 128, of the information handling system 100. The hardware microcontroller driver 178 receives actuation inputs from any of the sensor types and forwards those to computer-readable program code 118 of the closed lid interface control module 111 at the closed lid information handling system 100. In an embodiment, execution of computer-readable program code instructions 118 of the closed lid interface control module 111 may be conducted by an embedded controller 104 or a designated microcontroller unit (MCU) 110 in some embodiments although any hardware processing resource such as 102 is also contemplated.

The closed lid information handling system 100 receives input/output commands corresponding to these sensor actuation inputs as quick controls of executing software or firmware applications executing thereon. Further, the closed lid interface control module 111 may provide responsive feedback instructions as feedback to a sensor actuation input to indicate to a user that the sensor actuation has been received. Such responsive feedback instructions may be for a tone, haptic feedback/vibration, or beep played at a speaker 155 or for a light indication at the LED or other lighting 174 or at one or more other lights on the closed lid information handling system 100.

In further embodiments herein, lid sensor 159 detects and indicates an orientation mode of the laptop type information handling system to the closed lid interface control module 111. In embodiments herein, execution of computer-readable program code of the closed lid interface control module 111 may receive lid sensor actuation indicating a closed lid orientation transition from any open lid orientation. This may trigger activation of any of the closed lid interface system embodiments herein to make the various sensor types and hardware microcontroller driver 178 available to receive sensor actuation inputs. In one embodiment, transition to the closed lid orientation may trigger disabling the touchpad 156 for operation as a capacitive touchpad and switch the capacitive sensor(s) of the touchpad to be used with at least one closed lid interface system embodiment. In some embodiments herein, detection by the closed lid interface control module 111 of the closed lid orientation of the display device lid chassis 170 relative to a base chassis may enable a power source, or activate, any of the closed lid interface system types in embodiments herein.

Alternatively, execution of computer-readable program code of the closed lid interface control module 111 may receive lid sensor actuation indicating opening the display device lid chassis 170 relative to a base chassis indicating a transition away from a closed lid orientation to any open lid orientation. This may trigger deactivation of any of the closed lid interface system embodiments herein to make the various sensor types and hardware microcontroller driver 178 unavailable to receive sensor actuation inputs in some embodiments herein. In one embodiment, transition away from the closed lid orientation may trigger enabling the touchpad 156 for operation as a capacitive touchpad and disable use of the capacitive sensor(s) of the touchpad with at least one closed lid interface system embodiment. In embodiments herein, detection by the closed lid interface control module 111 of the closed lid orientation of the display device lid chassis 170 relative to a base chassis disenable a power source for any of the closed lid interface system embodiments herein.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

FIG. 2A is a perspective view graphic diagram illustrating a laptop type information handling system with an open lid having a first sensor system that is a capacitive sensor system of a closed lid interface system according to an embodiment of the present disclosure. FIG. 2B is a front view graphic diagram illustrating a laptop type information handling system with a closed lid and a first sensor system that is a capacitive sensor system for a closed lid interface system according to an embodiment of the present disclosure. FIG. 2A shows the laptop type information handing system 200 in an open lid configuration showing a base chassis 205, a display device lid chassis 270, a keyboard 252, and a display screen 250 according to an embodiment herein. The laptop type information handing system 200 also includes a touchpad 256 having an capacitive surface or an array of capacitive sensors in an embodiment. Further, laptop type information handing system 200 has lid sensor 259 shown in the base chassis 205, but could also be in the display device lid chassis 270, at a hinge or other location in some embodiments. In embodiments, lid sensor 259 may be hall sensors, microphones, light sensor, hinge sensor, gyro inertial motion unit sensors, or others to detect the orientation of the display device lid chassis 270 relative to a base chassis 205 of the information handling system 200 used to determine any orientation modes. For example, laptop open, closed lid, tablet, easel, tent or other orientations may be detected by the lid sensor 259 in embodiments herein.

In an embodiments herein, a closed lid interface system may utilize the capacitive sensor or sensors of touchpad 256 in the base chassis 205 or a separate base chassis strip capacitive sensor 257a or 257b to detect user actuation of a display device lid chassis 270 relative to the base chassis 205 via detected changes in capacitance in embodiments herein. The separate base chassis strip capacitive sensor 257a or 257b may be located in the base chassis 205 or the display device lid chassis 270 on a display screen 250 facing side in various embodiments. A hardware microcontroller driver is operatively coupled to receive actuation sensor inputs from a squeeze actuation 272 or a press actuation altering the capacitance detected at the base chassis strip capacitive sensor 257a or 257b or the touchpad 256 in embodiments herein during operation of the closed lid interface system in embodiments herein.

In an embodiment, hardware microcontroller driver may receive actuation sensor inputs from the base chassis strip capacitive sensor 257a or 257b or a touchpad 256 only when the lid sensor 259 detects that the laptop type information handling system 200 is in a closed orientation as shown in FIG. 2B. In embodiments herein, when the lid sensor 259 detects a closed lid orientation, the capacitive sensor layer or capacitive sensors of the touchpad 256 are disabled for touchpad operation and repurposed via connection to the hardware microcontroller driver as a capacitive sensor for the closed lid interface system. The resulting closed lid interface system provides for quick access control of a closed lid information handling system 100 via a squeeze or press actuation 272 of the digital display device lid chassis 270 relative to the base chassis using the repurposed touchpad capacitive sensor 256 or the base chassis strip capacitive sensors 257a or 257b according to embodiments herein. Thus, the closed lid interface system may be a low power system that may limit impact on operation of the hardware processor or power of the closed lid information handling system while still providing quick access control IO device commands via execution of computer readable program code of closed lid interface control module and actuation of the digital display device lid chassis 270. This closed lid interaction system further provide for limited alteration to the aesthetics of the digital display device lid chassis 270 in embodiments herein.

In one embodiment, the computer readable program code of the closed lid interface control module may receive the detected squeeze 272 or press actuation input and generate a button actuation type input IO command. The I/O command received is interpreted by the closed lid interface control module based on the running application in various embodiments herein. For example, if speakers are sounding an alert, a squeeze user input detected as a sensor actuation input will silence speakers in one embodiment. If device is executing a voice driven software application, a squeeze user input will trigger an action, such as voice dictation, in another example embodiment. If a conference call application is executing, a squeeze user input may trigger a microphone mute function in another example embodiment. In further embodiments, the closed lid interface control module may receive plural squeeze 272 or press actuation inputs in a succession, for example two or more squeezes or presses actuated within a threshold timeframe, as a second actuation type input IO command. In yet other embodiments, the closed lid interface control module may receive one or more squeeze 272 or press actuation inputs for a duration exceeding a threshold timeframe as a third actuation type input IO command. These squeeze 272 or press actuations of the display device lid chassis detected by the base chassis strip capacitive sensor 257a or 257b or the repurposed capacitive touchpad 256 may provide plural IO commands for quick access controls of the software applications executing on the closed lid information handling system 100 based on a number of squeezes 272 or presses or duration of a squeeze 272 or press detected by the closed lid interface system in an embodiment herein. Further, existing speaker, lighting, or haptics in the laptop type information handling system may provide responsive sound, light or haptic feedback in response to one or more squeeze 272 or press actuation inputs detected by the capacitive sensors 257a, 257b, or 256 and the hardware microcontroller driver in embodiments herein.

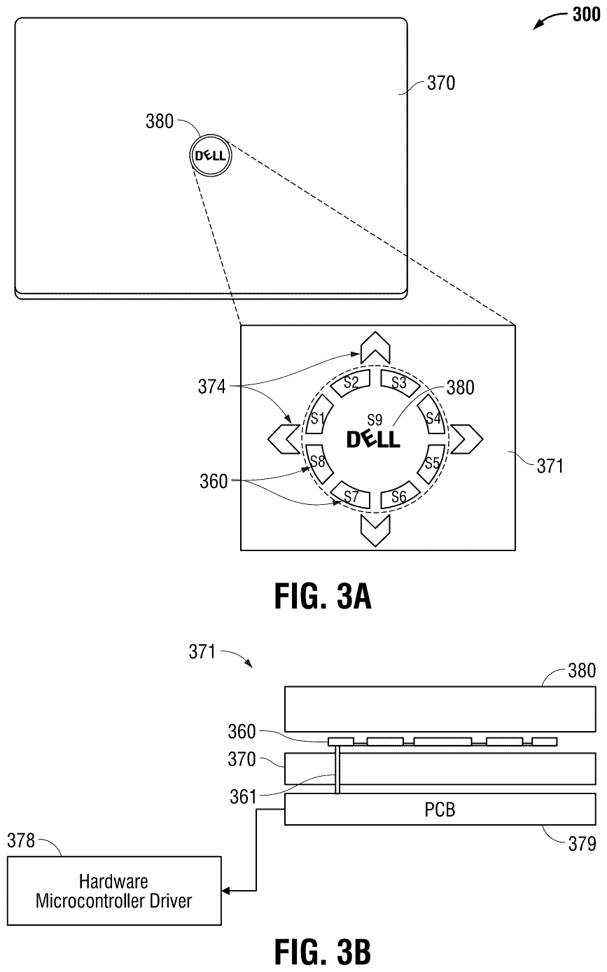

FIG. 3A is a top view graphic diagram illustrating a laptop type information handling system and magnified inset of a closed lid interface system with a lid capacitive sensor system according to another embodiment of the present disclosure. FIG. 3B is a side view graphic diagram illustrating a laptop type information handling system display chassis lid and a lid capacitive sensor system for a closed lid interface system according to another embodiment of the present disclosure. In an embodiment, a closed lid interface system 371 uses a lid capacitive sensor structure 360 utilizing an array or geometrically placed arrangement of capacitive sensors made of a conductive, capacitive sensor material disposed on or just under the surface of the outer cover of the display device lid chassis 370 or under a capacitive logo structure 380 on the display device lid chassis 370. The array or geometrically arranged capacitive sensors of the capacitive sensor structure 360 made of any capacitive sensor material having some conductivity, for example 50 ohms. The capacitive sensor material may be indium tin oxide (ITO) in one embodiment that is disposed on a flex circuit board as an array or geometrically arranged set of capacitive sensors of the capacitive sensor structure 360. The array or geometrically arranged set of capacitive sensors of the capacitive sensor structure 360 may be disposed as a perimeter of a geometric shape under a capacitive logo structure 380 or an interface panel structure on the display device lid chassis 370. The capacitive logo structure 380 or an interface panel structure on the display device lid chassis 370 may be metal or plastic, but the closed lid interface system is capable of still detecting capacitance of a user's touch of the capacitive logo structure 380 or the interface panel structure in embodiment. In various embodiments, the array or geometrically arranged capacitive sensors of the capacitive sensor structure 360 may detect touch or pretouch by a user on either a capacitive logo structure 380 or the interface panel structure to actuate the geometric arrangement of capacitor sensors for quick access controls to the closed lid interface system 371. While the embodiment shown in FIG. 3A shows a logo structure 380, the array or geometric arrangement of capacitive sensors may be on or under an interface panel structure on the display device chassis lid cover 370 for quick access controls to the closed lid interface system 371. As shown in FIG. 3B, the array or geometrically arranged capacitive sensors of the capacitive sensor structure 360 includes one or more flex circuits or wires 361 passing through a via in the surface of the display device lid chassis 370 from the array or geometric arrangement of capacitor sensors of the capacitive sensor structure 360 to a flexible printed circuit board (PCB) 379 and hardware microcontroller driver 378 within the display device lid chassis 370 in an embodiment.

A user may actuate the lid capacitive sensor structure 360 like a button may conduct a center actuation touch of a capacitive logo structure 380 or interface panel surface or select among plural buttons on different sides of the capacitive logo structure 380 or interface panel surface by a user's finger in one embodiment. In a one embodiment, various portions of the geometric arrangement of capacitive sensors used with the lid capacitive sensor structure 360 of the closed lid interface system 371 may operate relative to other portions of the geometric arrangement of capacitive sensors via relational touch sensing among the geometrically arranged capacitive sensors for scrolling or swipe type actuation by the finger of a user. Although a ring of capacitive sensors is shown as the capacitive sensor structure 360 in the embodiment of FIG. 3A, it is contemplated that the geometric arrangement of capacitive sensors used with the lid capacitive sensor structure 360 may be any number or arrangement of capacitive sensors in various geometric shapes under the capacitive logo structure 380 or an interface panel surface structure may be used. An actuation by touch or sweep of a finger across the capacitive logo structure 380 or the interface panel surface structure in the display device lid chassis 370 is thus detected by the geometric arrangement capacitive sensors to provide for directional x-y actuation for quick access controls in embodiments herein.

In various embodiments, a ring, rectangle, square, oval or other geometric arrangement of any number of capacitive sensors around the edges of the geometric shape are as the lid capacitive sensor structure 360 to provide 4-way or multi-way directional touch input by a user touching any side or portion of the capacitive logo structure 380 or the interface panel surface structure depending on the number of capacitive sensor used in the geometric arrangement. In one embodiment, the logo structure 180 or the interface panel surface structure may be round, but any suitable shape for the logo of the information handling system 100 or the interface panel surface structure is contemplated in other embodiments. In a further embodiment, the geometric arrangement of capacitive sensors are arranged on a perimeter of a geometric shape on a flexible PCB under the logo structure 380 or interface panel surface structure in the display device lid chassis 370 for the lid capacitive sensor structure 360. The logo structure or the interface panel surface structure on the display device lid chassis 370 should be partially conductive such that an actuation by touch or sweep of a finger across the at least partially conductive surface is detected by the geometrically placed arrangement capacitive sensors to provide for a variety of capacitive input actuations to the lid capacitive sensor structure 360 as described in embodiments herein. The actuation of the lid capacitive sensor structure 360 by touch is detected at the hardware microcontroller driver 378 and transmitted to the closed lid interface control module for conversion to a capacitive touch IO command for quick access control of the closed-lid information handling system. Various actuations with the geometrically placed arrangement of capacitive sensors provide for quick access controls of a closed lid interface system for the software applications executing the closed lid information handling system in embodiments herein.

In an embodiment, execution of the closed lid interface control module and the hardware microcontroller driver 378 on the PCB 379 may interface with a lighting module for LED lighting 374 that appears on or through the display device lid chassis cover surface around the logo structure 380 or interface panel surface structure of the closed lid interface system 371. The LED lighting 374 may interface with an LED light on the PCB 379 and may do so via a light guide or light control structure in embodiments herein. LED lighting 374 may be used with the closed lid interface system 371 to indicate the closed lid sensor system location or user actuation options, such as directionality arrow as shown, in some embodiments. In those embodiments, the hardware processing resource executes computer readable program code of the closed lid interface control module to engage with the LED lighting 374, such as with LED lights on a PCB 379 under the digital display lid chassis, to activate. In an embodiment, LED lighting 374 is located in a lighting zone in the display device lid chassis 370 that is machined, has an LED lighting receiver cavity formed underneath, or has a mesh structure to receive the LED lighting 374 or a light guide such that the LED lighting 374 illuminates through the outer cover of the display device lid chassis 370. As described, LED lighting 374 may highlight a logo structure or interface panel structure surface for the user actuation with the closed lid interface system or may indicate user actuation action options such as directions for directional user actuation or movement for swipe actuation in embodiments herein. Additionally, the LED lighting 374 may be used for lighting feedback to a received capacitive sensor touch input in some embodiments.

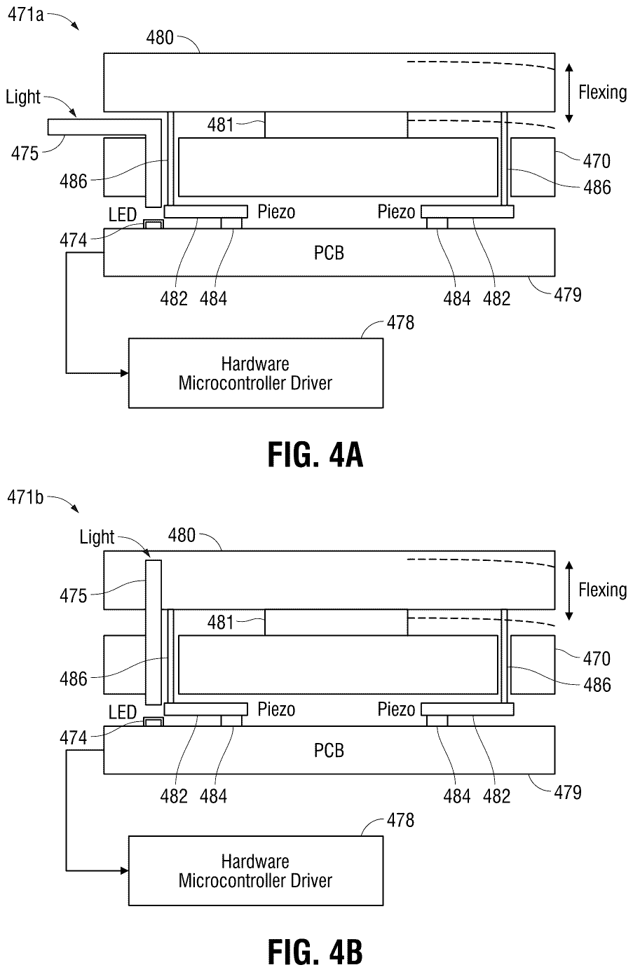

FIG. 4A is a side view graphic diagram illustrating a laptop type information handling system display chassis lid and a piezo sensor system as a piezo sensor structure with a first arrangement of lighting for a closed lid interface system according to an embodiment of the present disclosure. FIG. 4B is a side view graphic diagram illustrating a laptop type information handling system chassis lid and a piezo sensor structure for a closed lid interface system with a second arrangement of lighting according to yet another embodiment of the present disclosure. In another embodiment, a closed lid interface system uses a plurality piezo sensors 482 comprised of a piezoelectric material, such as piezoelectric crystalline material, piezoelectric ceramics material, or piezoelectric polymers, for a piezo sensor structure for the closed lid interface system. A plurality of piezo sensors 482 are disposed under a logo structure 480 or an interface panel surface structure on the cover surface of the display device lid chassis 470. The logo structure 480 or the interface panel surface structure is disposed atop a pedestal 481 and includes one or more piezo engagement pins 486 extending through vias in the cover surface of the display device lid chassis 470 to engage the deflectable piezo sensors 482 below. The piezo sensors 482 may respond to a slight deflection of the logo structure 480 or the interface panel surface structure on the pedestal 481 in embodiments herein. For further sensitivity of the piezo sensors 482, the piezoelectric material of the piezo sensors 482 may have a dive board structure with a fixed end held by a base anchor structure 484 to a printed circuit board 479 or other stiff structure in the display device lid chassis 470 in an embodiment. The dive board structure also has a free, deflectable end operably coupled to the piezo engagement pins 486 extending through the vias in the display device lid chassis 470 in embodiments herein.

The piezo sensors 482 may be directionally arranged under the logo structure 480 or the interface panel surface structure in the display device lid chassis 470 to be center-actuated or side actuated in a selected direction depending on where the logo structure 480 or the interface panel surface structure on pedestal 481 is deflected. A piezo sensor 482 located under a side that is pressed detects piezo actuation input from a user's press on the logo structure 480 or the interface panel surface structure in the display device lid chassis 470 in embodiments herein. It is contemplated that, in some embodiments, the interface panel surface structure in the display device lid chassis 470, appears as a region, medallion, disk, or panel flush with the outer surface of the display device lid chassis 470 and is situated on the pedestal structure 481 with piezo engagement pins 486 to detect slight deflection of the interface panel surface by a user's finger in embodiments herein. In one embodiment, a plurality of piezo sensors 482 may be disposed below the outer surface of the display device lid chassis 470 and under plural piezo engagement pins for x-y multi-directional actuation as well as center actuation for button like input by touch or press of the logo structure 480 or the interface panel surface structure in the display device lid chassis 470.

The directionally arranged piezo sensors 482 are arranged under the outer surface of the display device lid chassis 470 and are operatively coupled by wire to a PCB 479 and to the hardware microcontroller driver 478 in embodiments herein. Such an actuation by center actuation or directional x-y actuation may be used for quick access controls in embodiments herein. In this closed lid interface system embodiment, the piezo sensor structure actuation is detected at the hardware microcontroller driver 478 and transmitted to the closed lid interface control module for conversion to a piezo IO command for quick access control of the closed-lid information handling system. Various actuations by a user's finger applying force or pressing on the logo structure 480 or the interface panel surface structure in the display device lid chassis 470 is conveyed to the directionally arranged piezo sensors 482 by the piezo engagement pins 486 to provide for quick access controls of a closed lid interface system for the software applications executing the closed lid information handling system in another embodiment.

In an embodiment, execution of the closed lid interface control module and the hardware microcontroller driver 478 on the PCB 479 may interface with a lighting module for LED lighting 474 and a light guide 475 that appears on or through the display device lid chassis cover surface, around the logo structure 480 or interface panel structure of the closed lid interface system 471a as in FIG. 4A, or in the logo structure 480 or interface panel structure of the closed lid interface system 471b as in FIG. 4B. The LED lighting 474 may interface be an LED light on the PCB 479 and may transmit light via a light guide 475 or other light control structure in embodiments herein. FIG. 4A includes light guide 475 bent at the display device lid chassis to reflect and illuminate under the logo structure 380 in a first embodiment. FIG. 4B includes light guide 475 inserted into a lightguide receiver cavity formed in the logo structure 380 such that the material of the logo structure is thin enough or of a mesh structure to pass the light in a second embodiment.

LED lighting 474 may be used with the closed lid interface system 471a or 471b to indicate the closed lid sensor system location or user actuation options, such as directionality arrow as shown, in some embodiments. In those embodiments, the hardware processing resource executes computer readable program code of the closed lid interface control module to engage with the LED lighting 474, such as with LED lights on a PCB 479 under the digital display lid chassis 470, to activate. In an embodiment, LED lighting 474 may highlight a logo structure 380 or interface panel structure surface for the user actuation with the closed lid interface system or may indicate user actuation action options such as directions for directional user actuation or movement for swipe actuation in embodiments herein. Additionally, the LED lighting 474 may be used for lighting feedback to a received piezo sensor press input in some embodiments. In yet other embodiments, the same piezoelectric material of the piezo sensor 482 used to detect a finger press, or one or more of the other piezo sensors 482, is also enabled in the opposite direction to be driven by the hardware microcontroller driver 478 to provide haptic feedback to confirm user press actuation. When piezoelectric material is flexed it generates a piezo sensor signal. When driven by a signal from hardware microcontroller driver 478, the piezoelectric material flexes based on the signal profile as haptic feedback.

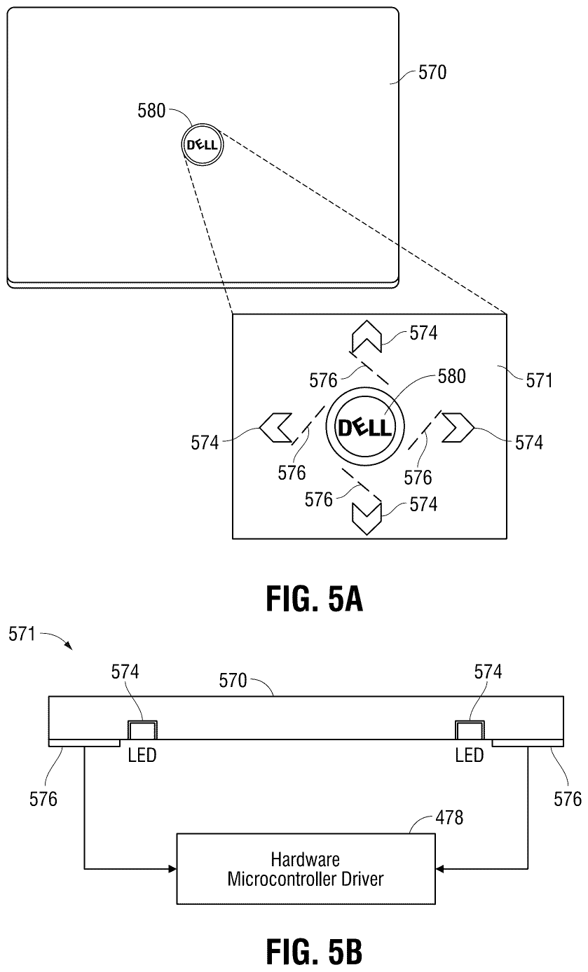

FIG. 5A is a side view graphic diagram illustrating a laptop type information handling system display chassis lid and magnified inset of a closed lid interface system with a strain gauge sensor system for according to an embodiment of the present disclosure. FIG. 5B is a side view graphic diagram illustrating a laptop type information handling system chassis lid and a strain gauge sensor system for a closed lid interface system according to another embodiment of the present disclosure. The shown strain gauge detectors 576 in the embodiments of FIG. 5A is a linear strain gauge sensor 576 such as the form of wire of strain gauge material. Other types strain gauge detectors 576 are also contemplated and could be in the form of a flex circuit strain gauge detector 576 with the strain gauge sensing material embedded an area on flexible PCB circuit such as round or square deposit of strain gauge sensing material carried on the flex PCB circuit. Any type of strain gauge detectors 576 may be used according to various embodiments herein.

In yet another embodiment, a closed lid interface system 571 uses a plurality of strain gauge detectors 576 disposed under any location of the outer cover surface for the display device lid chassis 570. Slight deflection of the metal or other material of the outer cover surface for the display device lid chassis 570 is detected by the deflectable strain gauge detectors 576 embedded within or below the outer cover surface for the display device lid chassis 570 in embodiments herein. The strain gauge detectors 576 under the outer cover surface for the display device lid chassis 570 are operably coupled to a hardware microcontroller driver 578. The strain gauge detectors 576 may be solid state strain gauge detectors 576, such as linear strain gauge detectors oriented at an angle to normal of a direction. Other types of strain gauges 576 are also contemplated. Example strain gauge detectors 576 include semiconductor piezo resistive strain gauges, capacitive strain gauges, bonded resistance strain gauges, bonded foil strain gauges, or the like in embodiments herein. Thus, slight deflection of the outer cover surface for the display device lid chassis 570 may deflect any of a plurality of disposed strain gauges 576 for a button type actuation or relational actuation at varying strain gauge detection levels for four way or more way x-y directional actuation by a touch or press of a user's finger at locations on the outer cover surface for the display device lid chassis 570 in embodiments herein.

The since the strain gauge detectors 576 may respond to a slight deflection of the metal or other surface of the display chassis lid cover, a centrally located strain gauge such as one disposed under central logo structure or a central location of the display device lid chassis 570 acting as an interface panel surface structure can be center-actuated to detect slight deflection of the outer cover surface for the display device lid chassis 570 as a button type actuation in some embodiments herein. In other embodiments, center actuation of a central location of the display device lid chassis 470 acting as an interface panel surface structure may be detected equally among plural directionally spaced strain gauge detectors for a button type actuation. In some embodiments, the directionally arranged strain gauge sensors 576 may be actuated at different directional locations across the outer cover surface for the display device lid chassis 570. Each directionally arranged strain gauge detector 576 may be oriented at an angle relative to a normal direction from the center for improved detection of strain gauge actuations as four way or more way x-y directional actuation among the directionally placed arrangement of the strain gauge detectors 576 in embodiments herein. In some embodiments, the angle of the strain gauge detectors 576 embedded in or under the outer cover surface for the display device lid chassis 570 may be at 30 degrees or 45 degrees from a normal linear direction emanating from the center of the outer cover surface for the display device lid chassis 570 to detect plural directional flex of a user's press at that location on the outer cover surface for the display device lid chassis 570. The strain gauge detectors 576 are disposed on or embedded into an under side of the outer cover surface for the display device lid chassis 570 and operatively coupled to a hardware microcontroller driver 578 for receiving the strain gauge actuations according to embodiments herein. Such a strain gauge actuation by center actuation or directional x-y actuation may be used for quick access controls in embodiments herein. As with each closed lid interface system embodiment, the strain gauge actuation is detected at the hardware microcontroller driver 578 and transmitted to the closed lid interface control module for conversion to a strain gauge IO command for quick access control of the closed-lid information handling system. Various actuations with the centrally located or directionally arranged strain gauge detectors 576 provide for quick access controls of a closed lid interface system for the software applications executing the closed lid information handling system in yet another embodiment.

In an embodiment, execution of the closed lid interface control module and the hardware microcontroller driver 578 may interface with a lighting module for LED lighting 574 that appears on or through the display device lid chassis cover surface of the closed lid interface system 571. The LED lighting 574 may interface with an LED light and may do so via a light guide or other light control structure in embodiments herein. LED lighting 574 may be used with the closed lid interface system 571 to indicate the closed lid sensor system location or user actuation options, such as directionality arrow as shown, in some embodiments. In those embodiments, the hardware processing resource executes computer readable program code of the closed lid interface control module to engage with the LED lighting 574, such as with LED lights on a PCB under the digital display lid chassis 570, to activate. In an embodiment, LED lighting 574 is located in a lighting zone in the display device lid chassis 570 that is machined, has an LED lighting receiver cavity formed underneath, or has a mesh structure to receive the LED lighting 574 or a light guide such that the LED lighting 574 illuminates through the outer cover of the display device lid chassis 570. As described, LED lighting 574 may highlight the display device lid chassis for the user actuation with the closed lid interface system or may indicate user actuation action options such as directions for directional user actuation or movement for swipe actuation in embodiments herein. Additionally, the LED lighting 574 may be used for lighting feedback to a received capacitive sensor touch input in some embodiments.

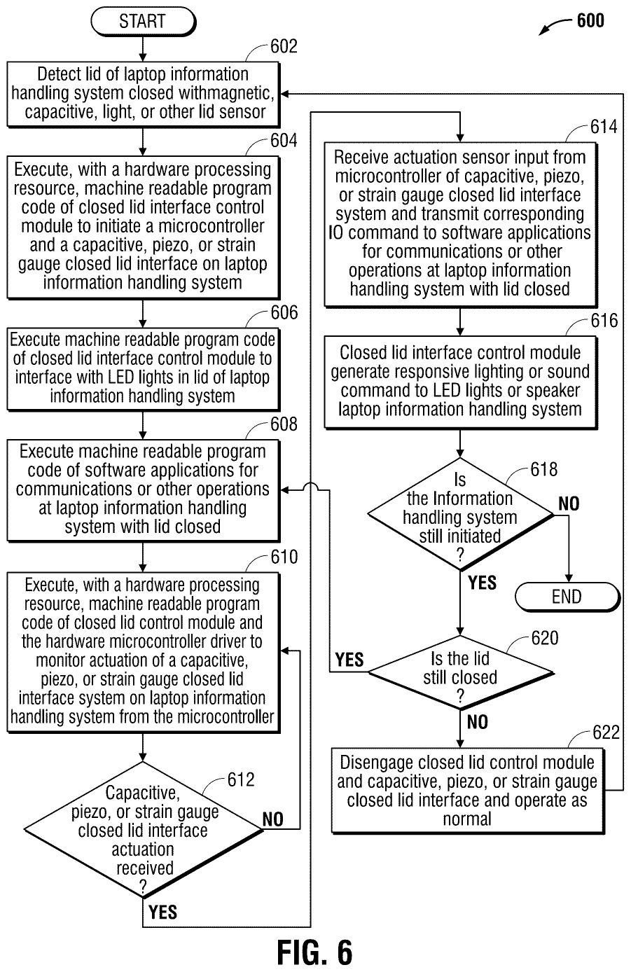

FIG. 6 is a flow diagram showing a method of operating a closed lid interface system with sets of sensors while executing machine-readable program code instructions for a closed lid interface control module for control of a laptop type information handling system in a closed lid orientation according to an embodiment of the present disclosure.

At block 602, a lid sensor of an information handling system is actuated to detect the lid orientation of the laptop type information handling system. The lid sensor may be hall sensor, a capacitive sensor, a light sensor or infrared sensor, a hinge sensor or another sensor in the laptop information handling system to detect the orientation of a display device lid chassis relative to a base chassis. The lid sensor may detect plural orientations including a closed lid orientation or other orientations when the display device chassis lid has been opened.

Proceeding to block 604, a hardware processing resource, such as an embedded controller or a hardware processor, at the information handling system will receive sensor indication from a lid sensor that it is in a closed lid orientation. The hardware processing resource will execute computer-readable program code of a closed lid interface control module to initiate a hardware microcontroller driver at the closed lid interface system as well as one or more actuation sensors at the closed lid interface system.

As described in an embodiment herein, the actuation sensors may include a touchpad capacitive sensor or a base chassis strip capacitive sensor to detect compression of a display device lid chassis relative to a base chassis of the information handling system for a detection of capacitance changes due to a squeeze or press user actuation on the display device lid chassis. In another embodiment, the actuation sensors may include a geometric arrangement of capacitive sensors around a perimeter of a geometric shape under a logo structure or an interface panel structure surface on the display device lid to detect touch user actuation on the logo structure or on the interface panel surface. Portions of the geometric arrangement of capacitive sensors around a perimeter of a geometric shape detect capacitance changes due the touch such as a button type touch, a directional type touch, or a swipe type touch among the geometric arrangement of capacitive sensors. In another embodiment, the actuation sensors may include a piezo sensors disposed under a display device lid chassis and a logo structure or an interface panel structure surface on the display device lid chassis to detect press user actuation on the logo structure or on the interface panel surface. The piezo sensor detect deflection of the logo structure or on the interface panel surface by the piezoelectric material of the piezo sensor for a button type press or a directional type press among the directionally located piezo sensors. In yet another embodiment, the actuation sensors may include a strain gauge detectors disposed under a display device lid chassis as an interface panel structure surface on the display device lid chassis to detect press user actuation on the display device lid chassis as an interface panel structure surface for a detection of deflection of the interface panel surface by the strain gauge detectors material for a button type press or a directional type press among the directionally located strain gauge detectors.

At block 606, lighting may be used with the closed lid interface system to indicate the closed lid sensor system location or user actuation options in some embodiments. In those embodiments, the hardware processing resource executes computer readable program code of the closed lid interface control module to engage with the lighting, such as LED lights, in the display device lid chassis or elsewhere on the information handling system to activate. Such lighting, with LED or other lights, may highlight a logo structure or interface panel structure surface for the user actuation with the closed lid interface system or may indicate user actuation action options such as directions for directional user actuation or movement for swipe actuation in embodiments herein. Further, lighting, such as with the LED lights, could be triggered ahead of press by detecting approaching finger with capacitive sensors or other proximity sensors in embodiments herein.

At block 608, the hardware processing resource to executes computer readable program code of software or firmware for user application or hardware operation on the information handling system even though in a closed lid orientation. For example, the closed lid information handling system may still conduct communication system for audio, email, messaging or other communications, software applications operating with voice activation, audio applications such as music or others, or other applications where quick access controls may be used.

Proceeding to block 610, a hardware processing resource, such as an embedded controller or a hardware processor, at the information handling system executes code instructions of the closed lid interface control module to monitor for sensor actuation inputs received from the hardware microcontroller driver of the actuation sensor structure of the closed lid interface system. As described, the actuation sensor structure may include one or more sensors that are a base chassis capacitive sensor, a geometric array of capacitive sensors, a plurality of piezo sensors, or a plurality of strain gauge detectors in embodiments herein. Actuation of any of these actuation sensor structures may be detected by an operatively coupled hardware controller driver in embodiments herein. Upon detection of sensor actuation of an actuation sensor by a user actuation such as a squeeze, touch, press or other, this sensor actuation is provided to the closed lid interface control module for translation into an IO command, selected from a plurality of IO commands in some embodiments, for quick access controls of the closed lid laptop information handling system.

At block 612, the hardware processing resource, such as an embedded controller or a hardware processor, at the information handling system executes code instructions of the closed lid interface control module to determine if sensor actuation input of the closed lid interface system has been received from the hardware microcontroller driver. For example, any of the sensor actuation embodiments herein, including capacitive sensor from a repurposed touchpad or base chassis strip capacitive sensor, from a lid capacitive sensor structure, from the piezo sensor structure, from the strain gauge detectors, or combined embodiments as an actuation sensor structure in the information handling system may be operational in various embodiments to receive a user's actuation detected as sensor actuation input by a hardware microcontroller driver in various embodiments herein. For example, a combination of an array of capacitive sensors in or under a logo structure or an interface panel surface structure may be implemented in combination with an operatively coupled one or more piezo sensor under the logo structure or interface panel surface structure on the display device lid chassis in one embodiment. In this example embodiment, either capacitive or piezo sensor actuation input or a combination of capacitive and piezo sensor actuation input may be received at block 612 in this example embodiment and used to provide a wide array of potential input commands depending on software or systems operation at the closed lid information handling system. This may include capacitive proximity sensing before touch or press for pre-lighting in some embodiments herein. Any combination of the sensor actuation embodiments described herein are contemplated.

If sensor actuation input is not received from the actuation sensor structure as detected by the hardware microcontroller driver of any embodiments herein, the flow returns to block 612 for continued monitoring for sensor actuation by a user. If sensor actuation input is received from the hardware microcontroller driver at block 614, the method proceeds to block 614.

At block 614, the sensor actuation input of the closed lid interface system received from the hardware microcontroller driver of the closed lid interface system is translated into an IO command by the closed lid interface control module, selected from a plurality of IO commands in some embodiments, for quick access controls of the software, firmware, or hardware operating on the closed lid laptop information handling system according to various embodiments herein. The number of successive sensor actuation input of the closed lid interface system received from the hardware microcontroller driver within a limited time period, such as 0.5 seconds or any period, may be used by the closed lid interface control module to select among the plurality of IO commands in an embodiment. A duration of sensor actuation input of the closed lid interface system received from the hardware microcontroller driver above or below a time threshold, such as 0.5 seconds or any period, may be used by the closed lid interface control module to select among the plurality of IO commands in another embodiment. Further, particular individual or groups of actuation sensors from a plurality of actuation sensors used with the actuation sensor structure of the closed lid interface system may be used in relation to other actuation sensors or groups of the actuation sensor structure to indicate relational actuation sensor input to the closed lid interface control module, such as directional sensor actuation input, swipe gesture actuation inputs, or scroll actuation inputs in example embodiments.

Proceeding to block 616, the closed lid interface control module to generates a responsive sound, piezo haptics, vibration, or lighting signal with the LED lights on the information handling system to indicate that the sensor actuation input has been received for a selected IO command in an embodiment. This may include providing a responsive sound command to a speaker on the closed lid information handling system such as a beep or tone in response to a sensor actuation input being received in one embodiment. In another embodiment, the LED lights integrated into the digital display lid chassis, a logo structure or interface surface panel structure, or elsewhere in the information handling system may receive a responsive lighting command to provide a responsive lighting indication to a sensor actuation input being received in another embodiment.

At block 618, the method 600 includes determining if the information handling system is still initiated. Where the information handling system is still initiated, the method 600 proceeds to block 620 to determine from a lid sensor if the information handling system is still in a lid closed orientation as described herein. Where the information handling system is no longer initiated, the method 600 may end here.

At block 620, the method 600 also includes the lid sensor detecting if the display device lid chassis is still in a closed lid orientation relative to a base chassis of the information handling system in embodiments herein. A hall effect sensor, capacitive lid sensor, optical lid sensor, a hinge sensor or other lid sensor may detect when the display device lid chassis is closed with respect to the base chassis of a laptop type information handling system in various embodiments. When the lid sensor reports that the display device lid chassis is still closed to the closed lid interface control module executing at the information handling system, the closed lid interface system embodiment is still active and the returns to block 608 for continued execution or one or more software or firmware applications at the closed lid information handling system. The hardware microcontroller driver of the closed lid interface system will continue to monitor for one or more sensor actuation inputs at the closed lid interface system embodiment operating on the information handling system and the method may proceed.

When the lid sensor reports that the display device lid chassis has been opened at block 620 to the closed lid interface control module executing at the information handling system, the closed lid interface control module operates to disengage the sensor structures of the closed lid interface systems of any of the various embodiments herein at block 622. For example, the sensors of various types for the closed lid interface system will be made unavailable in embodiments herein. In one embodiment of a closed lid interface system, the touchpad may be reengaged as a touchpad device and its capacitive sensor no longer used for a closed lid interface system embodiment. At block 622, the information handling system will operate as it normally would in any orientation to execute software or firmware applications, conduct communications, and interface with various IO devices. Flow may then return to block 602 for the lid sensor to detect and report closing of the lid to a closed lid orientation to the closed lid interface control module executing at the information handling system in embodiments herein.

The blocks of the flow diagram of FIG. 6 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

1. An information handling system with a closed lid interface system comprising:
a hardware processor, a memory, and a power source to provide power to the hardware processor and the memory;
a display device lid chassis including a display screen of a digital display device forming an inner surface of the display device lid chassis;
the closed lid interface system having an actuation sensor structure comprising a plurality of actuation sensors disposed within or under an interface panel formed as a designated portion of an outer surface of the display device lid chassis, wherein the actuation sensor structure detects a sensor actuation with a user's actuation of the interface panel in the outer surface of the display device lid chassis and the interface panel is of a same material as the outer surface of the display device lid chassis;
a lid sensor detecting a closed lid orientation of the display device lid chassis relative to a base chassis of the information handling system;
the actuation sensor structure formed into or under the interface panel operatively coupled to a printed circuit board and a hardware microcontroller driver disposed under the outer surface of the display device lid chassis to receive the sensor actuation from the user's actuation at the interface panel formed of the same material as the outer surface of the display device lid chassis and detected by at least one of the plurality of actuation sensors;
an embedded controller executing computer-readable program code of a closed lid interface control module to translate the sensor actuation that is detected from the user's actuation at the interface panel formed of the same material as the outer surface of the display device lid chassis, via the hardware microcontroller driver, into an input command for the information handling system executing in the closed lid orientation; and
the hardware processor to adjust closed lid operation of the information handling system from the input command translated from the received sensor actuation at the closed lid interface system.

2. The information handling system of claim 1, wherein the interface panel is a logo structure formed of the same material as the outer surface of the display device lid chassis and operatively coupled into the outer surface of the display device lid chassis and the logo structure has the plurality of actuation sensors disposed within or under the logo structure.

3. The information handling system of claim 1 further comprising:
the sensor structure of the closed lid interface system includes a geometric array of capacitive sensors comprised of indium tin oxide on a flex circuit board formed under a bottom side of the interface panel in the display device lid chassis and that is a designated area of the outer surface of the display device lid chassis, where the user's actuation is a touch of the interface panel at a first location detected by a first portion of the geometric array of capacitive sensors as the sensor actuation.

4. The information handling system of claim 3, wherein the sensor actuation of the first portion of the geometric array of capacitive sensors is detected relative to a second portion of the geometric array of capacitive sensors is received by the hardware microcontroller driver as an x-y directional sensor actuation.

5. The information handling system of claim 3, wherein the sensor actuation of the first portion of the geometric array of capacitive sensors includes movement of the user's touch on the interface panel across the first portion of the geometric array of capacitive sensors and is detected relative to a second portion of the geometric array of capacitive sensors is received by the hardware microcontroller driver as a swipe sensor actuation.

6. The information handling system of claim 1 further comprising:
the interface panel formed into the outer surface of the display device lid chassis is a pedestal interface panel structure operatively coupled to a plurality of piezo sensors disposed below the outer surface of the display device lid chassis by piezo engagement pins through the outer surface of the display device lid chassis, where deflection of the pedestal interface panel structure by the user's actuation is detected by at least one piezo sensor as the sensor actuation.

7. The information handling system of claim 6, further comprising:
the plurality of piezo sensors are arranged in plural directions from a center of the pedestal interface panel structure, and user actuation on any side off-center on the pedestal interface panel structure actuates a first piezo sensor of the plurality of piezo sensors arranged in the plural directions; and
the hardware microcontroller driver to receive the sensor actuation from the first piezo sensor as an x-y directional sensor actuation in a first direction.

8. The information handling system of claim 1 further comprising:
the interface panel formed into the outer surface of the display device lid chassis is a designated area of the outer surface itself of the display device lid chassis operatively coupled to a plurality of strain gauge sensors disposed below an underside of the outer surface of the display device lid chassis and operatively coupled to the hardware microcontroller driver, where deflection of an portion of the outer surface of the display device lid chassis by the user's actuation is detected by at least one strain gauge sensor as the sensor actuation.

9. The information handling system of claim 8, further comprising:
a plurality of strain gauge sensors are arranged in plural directions at an angle to a normal direction from a center of the outer surface of the display device lid chassis, and user actuation on a first location on the outer surface of the display device lid chassis actuates a first strain gauge sensor relative to the plurality of strain gauge sensors arranged in the plural directions; and
the hardware microcontroller driver to receive the sensor actuation from the first strain gauge sensor as an x-y directional sensor actuation in a first direction.

10. The information handling system of claim 1 further comprising:
the lid sensor detecting opening of the display device lid chassis relative to the base chassis and the information handling system is not in closed lid orientation; and
the hardware microcontroller driver suspending operation of the closed lid interface system when the display device lid chassis is opened.

11. A method of controlling an information handling system with a closed lid interface system comprising:
detecting, via a lid sensor, a closed lid orientation of a display device lid chassis relative to a base chassis of the information handling system to activate a closed lid interface system for quick access controls at the information handling system in the closed lid orientation;
detecting a sensor actuation with a user's actuation of an interface panel in the outer surface of the display device lid chassis to actuate a sensor structure comprising a plurality of actuation sensors disposed under a bottom surface of the interface panel of the closed lid interface system, wherein a display panel forms an inner surface of the display device lid chassis;
receiving the sensor actuation from a user interaction on an interface panel from at least one of the plurality of actuation sensors formed under the interface panel and received at an operatively coupled printed circuit board and a hardware microcontroller driver disposed under the outer surface of the display device lid chassis, wherein the interface panel is a designated portion of the outer surface of the display lid device chassis formed of the same material as a remaining portion of the outer surface of the display device lid chassis;
executing computer-readable program code of a closed lid interface control module, via an embedded controller, to translate the sensor actuation due to the user interaction from the hardware microcontroller driver into an input command for a quick access control for the information handling system executing in the closed lid orientation;
adjusting closed lid operation of the information handling system, via the hardware processor, pursuant to the input command translated from the received sensor actuation at the closed lid interface system; and
detecting opening of the display device lid chassis relative to the base chassis, via the lid sensor, and suspending operation of the closed lid interface system, via the hardware microcontroller driver, when the information handling system is not in the closed lid orientation.

12. The method of claim 11 further comprising:
detecting a touch of the interface panel as the user interaction at a first location with a first portion of a geometric array of capacitive sensors comprised of indium tin oxide as the actuation sensor, where the geometric array of capacitive sensors are disposed under a bottom surface of the interface panel in a perimeter geometric shape and are the plurality of actuation sensors of the sensor structure of the closed lid interface system; and
receiving sensor actuation of the first portion of the geometric array of capacitive sensors at the hardware microcontroller driver, where the first portion of the geometric array of capacitive sensors provide for directional x-y user actuation or swipe user actuation for quick access controls of the information handling system in the closed lid orientation.

13. The method of claim 11 further comprising:
receiving deflection of a side of the interface panel in the outer surface of the display device lid chassis, where the interface panel is a pedestal interface panel structure formed into the outer surface of the display device lid chassis and formed of the same material as the outer surface of the display device lid chassis and is operatively coupled to a plurality of piezo sensors disposed below the outer surface of the display device lid chassis by piezo engagement pins through the outer surface of the display device lid chassis;
detecting a deflection of the pedestal interface panel structure with at least one piezo sensor as the sensor actuation at the hardware microcontroller driver, where the plurality of piezo sensors provide for button user actuation or directional x-y user actuation for quick access controls of the information handling system in the closed lid orientation; and
driving a signal to at least one piezo sensor to provide haptic feedback in response to the sensor actuation.

14. The method of claim 13, wherein the plurality of piezo sensors have a dive board mounted structure of piezoelectric material operatively coupled to the piezo engagement pins at a freely moving end of the dive board mounted structure of the piezoelectric material.

15. The method of claim 11 further comprising:
receiving deflection of the outer surface of the display device lid chassis, where a portion of the outer surface of the display device lid chassis itself is the interface panel of the same material as the remaining portion of the outer surface of the display device lid chassis;
detecting the received deflection of the outer surface of the display device lid chassis with at least one strain gauge sensor as the sensor actuation, where the sensor structure includes a plurality of strain gauge sensors disposed below the outer surface of the display device lid chassis and operatively coupled to the hardware microcontroller driver; and
receiving, via the hardware microcontroller driver, the sensor actuation from the first strain gauge sensor, where the plurality of strain gauge sensors provide for button user actuation or directional x-y user actuation for quick access controls of the information handling system in the closed lid orientation.

16. The method of claim 11, wherein the interface panel is a logo operatively coupled into the outer surface of the display device lid chassis and formed of the same material as the outer surface of the display device lid chassis.

17. An information handling system with a closed lid interface system comprising:
a hardware processor, a memory, and a power source to provide power to the hardware processor and the memory;
a display device lid chassis including a display screen of a digital display device forming an inner surface of the display device lid chassis;
a lid sensor detecting a closed lid orientation of a display device lid chassis relative to a base chassis of the information handling system to activate the closed lid interface system;
the closed lid interface system having a sensor structure comprising a capacitive sensor disposed at the base chassis of the information handling system, wherein the sensor structure detects a sensor actuation with a user's actuation of the display device lid chassis relative to the base chassis that is a squeeze or press on an outer surface of the display device lid chassis when the display device lid chassis is closed with respect to the base chassis of the information handling system;
the sensor structure operatively coupled to a hardware microcontroller driver to receive the sensor actuation from the capacitive sensor in the base chassis from the squeeze or press on outer surface of the display device lid chassis;
an embedded controller executing computer-readable program code of a closed lid interface control module to translate the sensor actuation of the capacitive sensor disposed in the base chasses from the user's actuation of the outer surface of the display device lid chassis relative to the base chassis that is the squeeze or press on the outer surface of the display device lid chassis the hardware microcontroller driver into an input command for the information handling system executing in the closed lid orientation; and
the hardware processor to adjust closed lid operation of the information handling system from the input command translated from the received sensor actuation at the closed lid interface system.

18. The information handling system of claim 17 further comprising:
the capacitive sensor is a capacitive sensor array of a touchpad in the base chassis that is disengaged as a touchpad upon detection of the closed lid orientation by the lid sensor and operatively coupled to the hardware microcontroller driver as the capacitive sensor for the closed lid interface system when the information handling system is in the closed lid orientation.

19. The information handling system of claim 17, wherein the capacitive sensor is a base chassis capacitive strip sensor disposed in the base chassis to detect deflection of the outer surface of the display device lid chassis compressed toward the base chassis by the user's actuation user's actuation of the display device lid chassis relative to the base chassis that is the squeeze or press on the outer surface of the display device lid chassis.

20. The information handling system of claim 17 further comprising:
the lid sensor detecting opening of the display device lid chassis relative to the base chassis and the information handling system is not in closed lid orientation; and
the hardware microcontroller driver suspending operation of the closed lid interface system when the display device lid chassis is opened.
